(19) United States
(12) Patent Application Publication
(10) Pub. No.: US 2012/0173344 A1
(43) Pub. Date: Jul. 5, 2012

(54) ESTIMATING BID PRICES FOR KEYWORDS

(75) Inventors: Tao Zhang, Hangzhou (CN); Jiaqing Guo, Hangzhou (CN)

(73) Assignee: ALIBABA GROUP HOLDING LIMITED, George Town (KY)

(21) Appl. No.: 13/334,667

(22) Filed: Dec. 22, 2011

(30) Foreign Application Priority Data
Dec. 30, 2010 (CN) 201010616517.5

(51) Int. Cl. G06Q 30/02

(52) U.S. Cl. 705/14.71

(57) ABSTRACT

Estimating bid prices for keywords is disclosed, including: receiving a request to estimate a bid price associated with a target keyword for a bidder; determining whether the bidder has previously bid on the target keyword; in the event that the bidder has not previously bid on the target keyword, determining an estimated bid price based at least in part on a plurality of historical bid prices associated with the bidder corresponding to keywords other than the target keyword and a plurality of historical bid prices associated with other bidders corresponding to the target keyword; and in the event that the bidder has previously bid on the target keyword, determining the estimated bid price based at least on revising a current bid price associated with the request; and returning the estimated bid price associated with the target keyword.

### CROSS REFERENCE TO OTHER APPLICATIONS

This application claims priority to People's Republic of China Patent Application No. 201010616517.5 entitled A METHOD AND SYSTEM OF RETURNING ESTIMATED VALUES FOR KEYWORDS filed Dec. 30, 2010 which is incorporated herein by reference for all purposes.

### FIELD OF THE INVENTION

The present disclosure involves the field of internet advertising. In particular, it relates to techniques for estimating bid prices for keywords.

### BACKGROUND OF THE INVENTION

In pay per click (or cost per click), advertising, websites or search engines provide advertisers (sometimes referred to as bidders) keywords for the placement of advertising. For example, bidders can purchase search keywords so that when a search keyword appears in a search (e.g., at a search engine), an advertisement of a bidder that has bid on that search keyword will appear with the web content (e.g., search results) returned based on the search. For each click on an advertisement (e.g., a banner and/or sponsored link), the bidder pays the bid price (or the purchase price, which is another price based at least in part on the bid price) to the entity (e.g., search engine) that put the advertisement on display. Websites or search engines can use certain rules to display the bidder's advertisements in certain positions on their webpage based at least in part on their bid prices of the keywords. Generally, the higher the bid price of a keyword, the greater the chance that the corresponding advertisement will appear in an advantageous position on the webpage.

Some websites or search engines perform estimations of the bid prices of certain keywords for bidders. The bidders can also modify the estimated bid prices based on their own needs and circumstances. In one conventional technique of estimating bid prices of keywords for bidders, the estimation of a keyword is the same for all bidders.

However, one drawback of generating the same bid price estimate for a particular keyword for all bidders is that in practice, different bidders have varying budgets for their advertising campaigns and the interest of different bidders with respect to the same keyword also varies. Therefore, if the same estimated bid price for each keyword is returned to all bidders, the rate at which bidders accept the estimated bid prices for keywords are affected. Additionally, if a bidder is unable to accept the prices recommended by a website or search engine server, or if the server is unable to recommend desirable prices to bidders, bidders may repeatedly submit requests for bid price estimates that result in increased stress in processing at the server. Also, the website or search engine associated with computing the estimated bid prices using the conventional techniques takes up significant server resources.

### BRIEF DESCRIPTION OF THE DRAWINGS

Various embodiments of the invention are disclosed in the following detailed description and the accompanying drawings.

FIG. 1 is a diagram showing an embodiment of a system for providing estimates of bid prices.

FIG. 2 is a flow diagram showing an embodiment of a process for estimating a bid price of a target keyword for a bidder.

FIG. 3 is an example of a process of determining an estimated bid price in the event that the bidder has not previously bid on a target keyword before.

FIG. 4 is an example of a process of determining an estimated bid price in the event that the bidder has previously bid on a target keyword.

FIG. 5 is a flow diagram showing an example of a process for returning an estimated bid price.

FIG. 6 is a diagram showing an embodiment of a system for providing estimates of bid prices of target keywords.

FIG. 7 is an example of a feedback module.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In various embodiments, the techniques disclosed are used with the pay per click internet advertising model used to direct traffic to websites. Generally, advertisers pay an online publisher (e.g., website or search engine operator) a purchase price when an advertisement is clicked on by a bidder. In various embodiments, the techniques disclosed herein can be used with the model of pay per click that involves advertisers bidding on search keywords (as opposed to paying flat rates for search keywords) relevant to their target market. In a bid-based pay per click model, an advertiser competes with other advertisers in a private auction. The advertiser informs the host of the auction of the maximum amount (bid price) that he/she is willing to pay for a given ad spot (based on the search keyword). Then, in response to each time a visitor action triggers the ad spot, the auction will play out. For example, if the publisher were a search engine, then the auction can play out as follows: in response to a search query input at the search engine, all bids for the search keyword(s) included in the query that target the searcher's location, date and time of search, etc., are compared and the winning advertiser is determined for each triggered ad spot (e.g., location to display an advertisement among web content). The advertisements associated with the winning advertisements are then displayed at the ad spots among the search results. A winning advertiser whose advertisement is displayed may pay a purchase price, which can be the advertiser's bid price or less (e.g., the purchase price can be the second highest bid price or just a cent more than the second highest bid price).

Estimating bid prices of keywords is disclosed. In various embodiments, an estimated bid price for a target keyword is determined for a bidder based on historical bidding data (e.g., data relevant to that bidder and/or to the target keyword). In some embodiments, the estimated bid price refers to a price that the system recommends for the bidder for that target keyword based on historical data associated with the bidder. In some embodiments, whether the bidder has ever previously submitted a bid on a particular keyword is included in the estimation of the bid price. By using historical bidding data relevant to the bidder to estimate a keyword's bid price, the estimated bid price can better reflect the bidder's particular historical budget and/or historical interest in the keyword. The improved bid price estimate for a keyword should be at least close to a value that the bidder finds acceptable, which thus reduces the likelihood that the bidder will submit repeated requests for new bid price estimations that could burden the server's processing power.

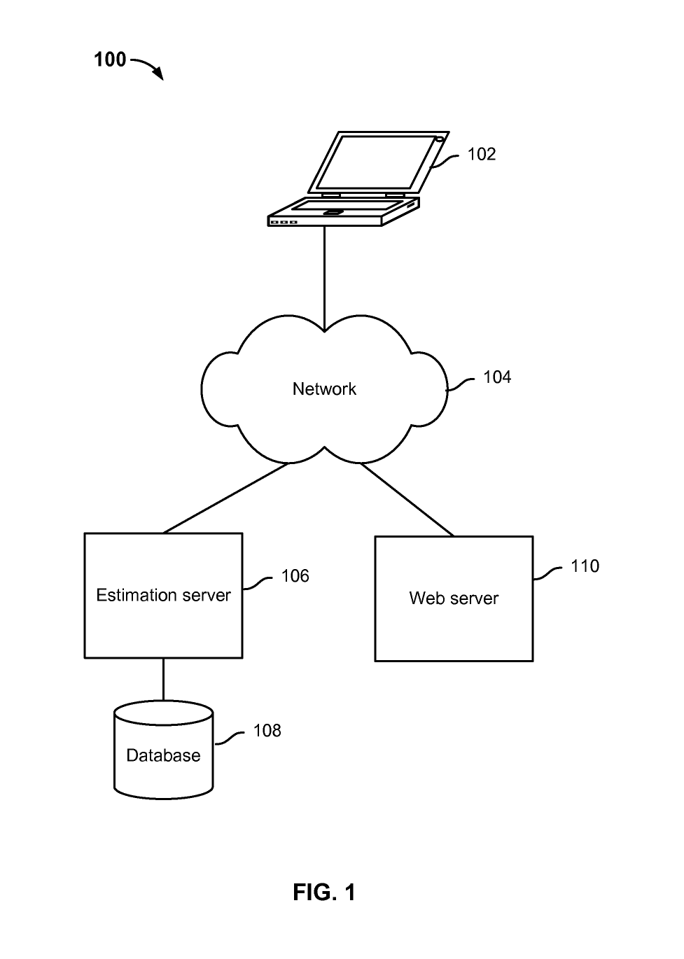

FIG. 1 is a diagram showing an embodiment of a system for providing estimates of bid prices. System 100 includes device 102, network 104, estimation server 106, database 108, and web server 110. In some embodiments, network 104 is implemented using high-speed data networks and/or telecommunications networks. In some embodiments, estimation server 106 and web server 110 are configured to work separately but coordinate with each other and in some embodiments, estimation server 106 and web server 110 are configured to work in combination. In some embodiments, web server 110 supports a website and/or a search engine at which advertisements can be displayed.

Examples of device 102 include a laptop computer, a desktop computer, a smart phone, a mobile device, a tablet device or any other computing device. Device 102 is configured to communicate with estimation server 106. In various embodiments, an application such as a web browser is installed at device 102 to enable communication with estimation server 106. For example, a bidder at device 102 can access a website associated with/hosted by web server 110 by entering a certain uniform resource locator (URL) at the web browser address bar. For example, web server 110 can be associated with an electronic commerce website. A bidder (e.g., an advertiser) can submit a bid price estimate request at device 102 to estimation server 106. For example, the bid price estimate request can include a target keyword, a current bid price, and sometimes, historical bidding data. Device 102 can also display the estimated bid price returned from estimation server 106. In some embodiments, estimation server 106 returns the estimated bid price as the recommended bid price for the bidder.

In some embodiments, a bidder can submit a bid price estimate request that includes a target keyword to receive from estimation server 106 the recommended bid price (i.e., the estimated bid price) for the bidder to use for the target keyword. The bidder can submit the recommended bid price to the pay per click service associated, for example, to the electronic commerce website so that the bidder can advertise on the website. In making the estimated bid price, estimation server 106 uses historical bidding data to determine an appropriate bid price for the bidder and the particular target keyword, as will be described below.

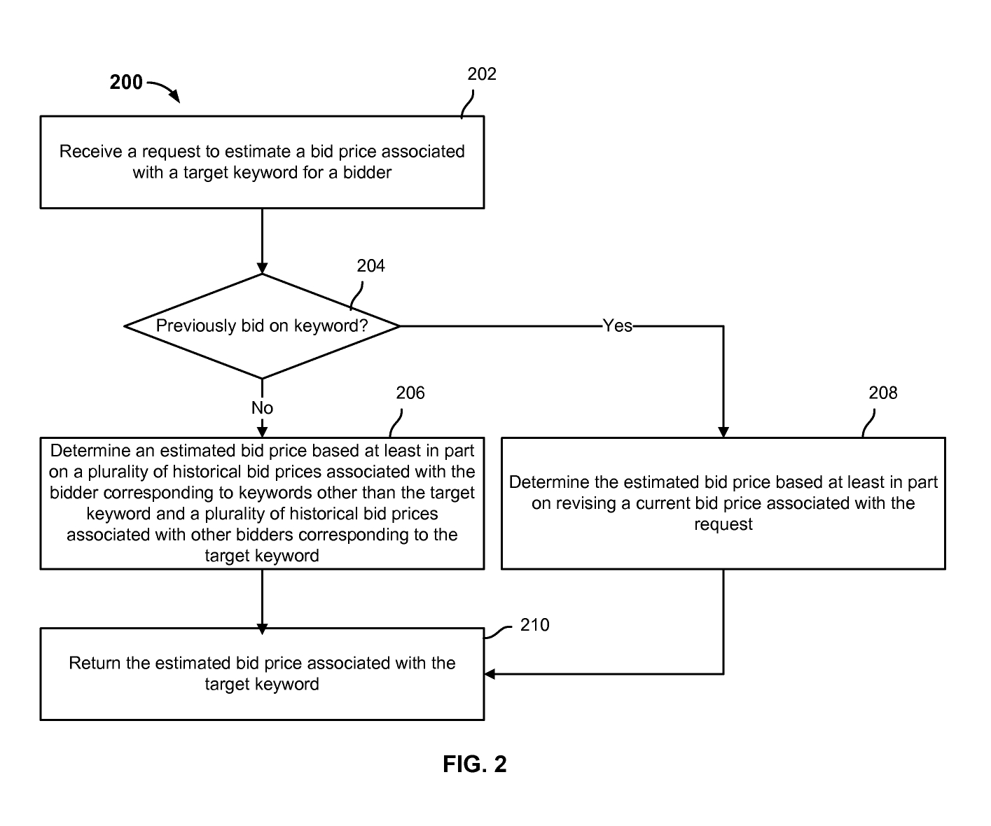

FIG. 2 is a flow diagram showing an embodiment of a process for estimating a bid price of a target keyword for a bidder. In some embodiments, process 200 is implemented at system 100.

At 202, a request to estimate a bid price associated with a target keyword for a bidder is received.

In various embodiments, the bid price associated with the target keyword is to be used in online advertising, for example, at a website or search engine. For example, the request can be submitted to a server associated with the website or search engine at which advertisements are to be displayed so that the website or search engine can recommend bid prices of target keywords that suit the needs of potential advertisers. For example, the request can be submitted by a bidder at a web browser-based application.

In some embodiments, the request includes an identifier associated with the bidder, the target keyword (e.g., “magazine”), the bidder's current bid price for the target keyword, and/or historical bidding data associated with the bidder. For example, the historical bidding data associated with the bidder can be stored at the device used by the bidder to submit bid prices for target keywords. In some embodiments, the bidder's current bid refers to the bidder's most recent bid for the target keyword. In some embodiments, the bidder's current bid refers to a bidder's own suggested bid price for the target keyword that could be subject to adjustment (by the system's estimated/recommended bid price).

At 204, it is determined whether the bidder has previously bid on the target keyword.

In some embodiments, the website or search engine determines whether or not the bidder has ever previously bid for the target keyword based at least on historical bidding data included in the request and/or historical bidding data stored at the server. For example, if the historical bidding data indicates that the bidder has previously bid on the target keyword once or more than once, then the bidder is determined to have previously bid for the target keyword. Otherwise, if the historical bidding data indicates that the bidder has never bid on the target keyword, then the bidder is determined to have not previously bid for the target keyword. Data used as the basis for the determination of 204 can be data other than historical bidding data and/or other techniques can be used to determine whether the bidder has previous bid on the target keyword.

In the event that it is determined that the bidder has previously bid on the target keyword, then control passes to 208. Otherwise, in the event that it is determined that the bidder has not previously bid on the target keyword, control then passes to 206.

At 206, the estimated bid price is determined based at least in part on a plurality of historical bid prices associated with the bidder corresponding to keywords other than the target keyword and a plurality of historical bid prices associated with other bidders corresponding to the target keyword.

When the bidder associated with the request has not previously engaged in bidding for the target keyword, the website or search engine determines the estimated bid price based on bidder's historical bidding data for other keywords and other bidders' historical bidding data for the target keyword.

At 208, the estimated bid price is determined based at least in part on revising a current bid price associated with the request.

When the bidder has previously submitted a bid price for the target keyword, the website or search engine will revise the current bid price included in the request. In some embodiments, the bidder's current bid price is revised based at least on all of the bidders' historical bidding data for the target keyword, so that the revised estimated bid price accounts for the bidder's price acceptance level and keyword sensitivity level as reflected in the bidder's history of submitted bid prices. In some embodiments, the current bid price is also revised based on historical bidding data associated with other bidders.

At 210, the estimated bid price for the target keyword is returned to the bidder/advertiser as the recommended bid price, or further processed then returned.

In some embodiments, the estimated bid price for the target keyword is returned to the client as the recommended bid price, without further processing. For example, the estimated bid price can be displayed to the bidder at a client device as a recommended bid price that the bidder can accept, ignore, or modify (e.g., via a selection on the display).

In some embodiments, the estimated bid price is further processed before being returned as the recommended bid price.

In some embodiments, further processing can include comparing the estimated bid price to a determined upper price limit for the target keyword for the bidder associated with the request. If the estimated bid price is equal or greater than the upper price limit, then the upper price limit is returned. Otherwise, if the bid price is less than the upper price limit, the estimated bid price is returned.

The determined bidder's upper price limit refers to the highest amount that the bidder is willing to pay for a target keyword. A bidder's upper price limit can be determined, for example, based on that bidder's budget and interest in the target keyword. When the estimated bid price exceeds the bidder's upper price limit, then it is assumed that the bidder will find the estimated bid price to be unacceptable and will not choose to submit that bid price for the target keyword.

For example, the upper price limit for the target keyword for the bidder can be determined as follows:

First, the bidder's mean purchase price (mean) and standard deviation (sd) of the target keyword are determined based on the bidder's historical purchase data. In some embodiments, the bidder's historical purchase data is stored at the server.

A log-normal distribution function is used to obtain the log-normal distribution mean u of the bidder's purchase prices for the keywords:

u=ln(mean)−0.5×ln(1+sd²/mean²).

Once u is determined, it is used to determine the upper price limit Q for the target keyword where Q=e^{u}.

The above described technique is one possible way of determining the bidder's upper price limit for the target keyword and other appropriate techniques may be used as well. In another example, predicted income and expenses associated with a keyword can be first predicted using scenarios in which the bidder offers different possible bid prices. Then, the predicted income and expenses can be used to obtain the bid price when the bidder's income is the greatest, and this bid price can be used as the upper price limit for the target keyword.

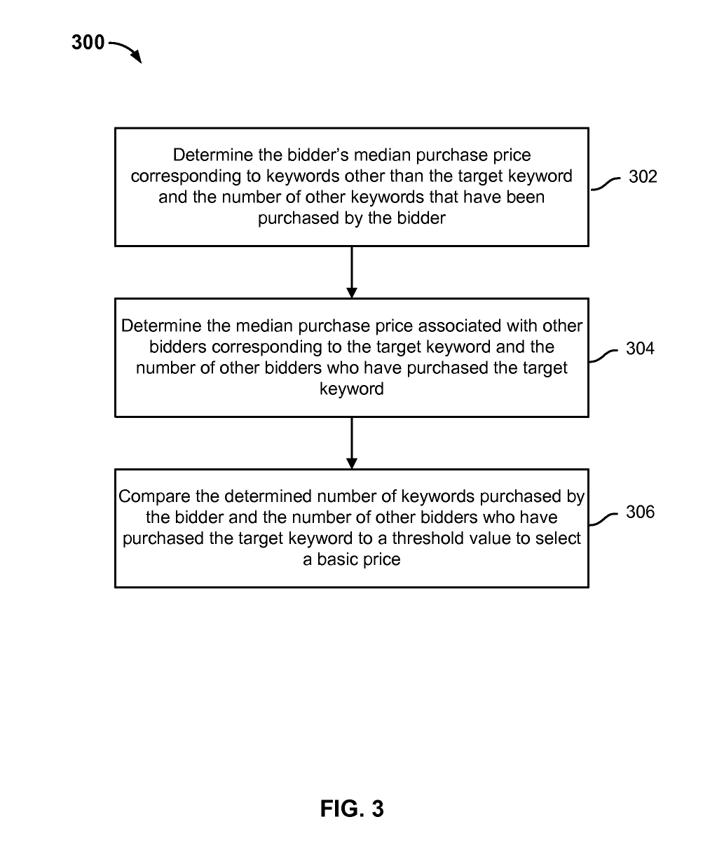

FIG. 3 is an example of a process of determining an estimated bid price in the event that the bidder has not previously bid on a target keyword before. In some embodiments, process 300 is used to implement 206 of process 200.

In process 300, the estimated bid price is determined for a target keyword included in a request submitted by a particular bidder.

At 302, the bidder's median purchase price corresponding to keywords other than the target keyword and the number of other keywords that have been purchased by the bidder are determined.

For example, the bidder's median purchase price corresponding to keywords other than the target keyword can be represented by P1 and the number of the other keywords can be represented by N1.

As mentioned above, the purchase price of a keyword is associated with the price that the bidder (e.g., advertiser) whose displayed advertisement was actually selected (e.g., clicked on) by a visitor to the website or search engine pays. In the pay per click bidding model, the purchase price can be as high as the bidding price submitted by the advertiser, but can also be lower than that price, depending on the purchase price determination rules of the website or search engine.

Although the bidder has not previously engaged in bidding for the target keyword, the bidder's preference/acceptance of bid prices and sensitivity with respect to keywords other than the target keyword can be inferred based on the bidder's historical purchase prices for the other keywords. For example, keywords other than the target keyword could include keywords that have been bid on at the website or search engine and are included in such historical bidding data associated with the website or search engine or can be included with the bid price estimate request. The historical bidding data can be used, in some embodiments, to determine the bidder's median purchase price P1 and the number of the other keywords N1.

At 304, the median purchase price associated with other bidders corresponding to the target keyword and the number of other bidders who have purchased the target keyword are determined.

For example, the median purchase price associated with other bidders corresponding to the target keyword can be represented by P2 and the number of other bidders who have purchased the target keyword can be represented by N2.

When determining an estimated bid price for the bidder, in some embodiments, not only is the bidder's own historical bidding data considered, but the historical bidding data/purchase prices of other bidders for the target keyword are also considered.

The following is an example of a technique for obtaining P1, P2, N1 and N2. The historical bidder bidding data/purchase price data is accessed and the purchase prices that the bidder has paid for a keyword other than the target keyword are placed into a first array that is arranged in either ascending or descending order. Then, the bidder's median purchase price P1 for keywords other than the target keyword is selected as the purchase price located in the middle of the array. The historical bidding data/purchase price data associated with other bidders is accessed and the purchase prices that other bidders have paid for the target keyword are placed into a second array that is arranged in either ascending or descending order. Then, the median purchase price P2 of other bidders' for the target keyword is selected to be the purchase price located in the middle of the array. N1, the number of keywords other than the target keyword that the bidder has purchased, is the number of values in the first array and N2, the number of other bidders who have purchased the target keyword, is the number of values in the second array. If the values of N1 or N2 are even numbers, i.e., if two purchase prices are located in the middle position of either array—then the mean of these two prices is taken as the median.

At 306, the determined number of other keywords purchased by the bidder and the number of other bidders who have purchased the target keyword are compared to a threshold value to select a basic price.

For example, the threshold value can be represented by T and the basic price can be represented by Pb. In various embodiments, in process 300, the basic price is determined to be the estimated bid price of the bidder associated with the request.

In some embodiments, the basic price can be determined using the following formula:

$$Pb = \{ \begin{matrix}max ( P 1 , P 2 ) & N 1 \geq T , N 2 \geq T \\ max ( P 1 , P 2 ) & N 1 < T , N 2 < T \\ P 1 & N 1 \geq T , N 2 < T \\ P 2 & N 1 < T , N 2 \geq T\end{matrix} \qquad ( 1 )$$

In some embodiments, a sample size threshold value T can be predetermined. It is generally held that samples are statistically significant when they reach a certain size. Applied to the present application, T can be set (e.g., by a system administrator) to be a threshold for determining whether the size of a certain sample is statistically significant. So, the values of N1 and N2 can be compared against threshold value T to determine whether they are statistically significant. For example, T can be set to 30 or any other appropriate value for the application. Based on formula (1) above, when one of N1 and N2 is greater than threshold value T, then the median corresponding to the N1 or N2 that is greater than threshold value T is determined as basic price Pb. But when the values of N1 and N2 are both greater than threshold value T, P1 and P2 are both considered to be statistically significant. Then, whichever one of P1 and P2 that has the greater value is determined as basic price Pb. If the values of P1 and P2 are both less than threshold value T, then whichever one of P1 and P2 that has the greater value is determined as basic price Pb. If P1 and P2 are equal, there is no need to compare either N1 or N2 against threshold value T and the value of P1 or P2 (because P1=P2) is determined as basic price Pb.

Another example for determining the basic price is as follows:

First, the bidder's median purchase price for keywords other than the target keyword P1 is determined. Then, the median purchase price associated with other bidders corresponding to the target keyword P2 is determined. Lastly, the average of P1 and P2 is determined to be basic price Pb, which is also the estimated bid price.

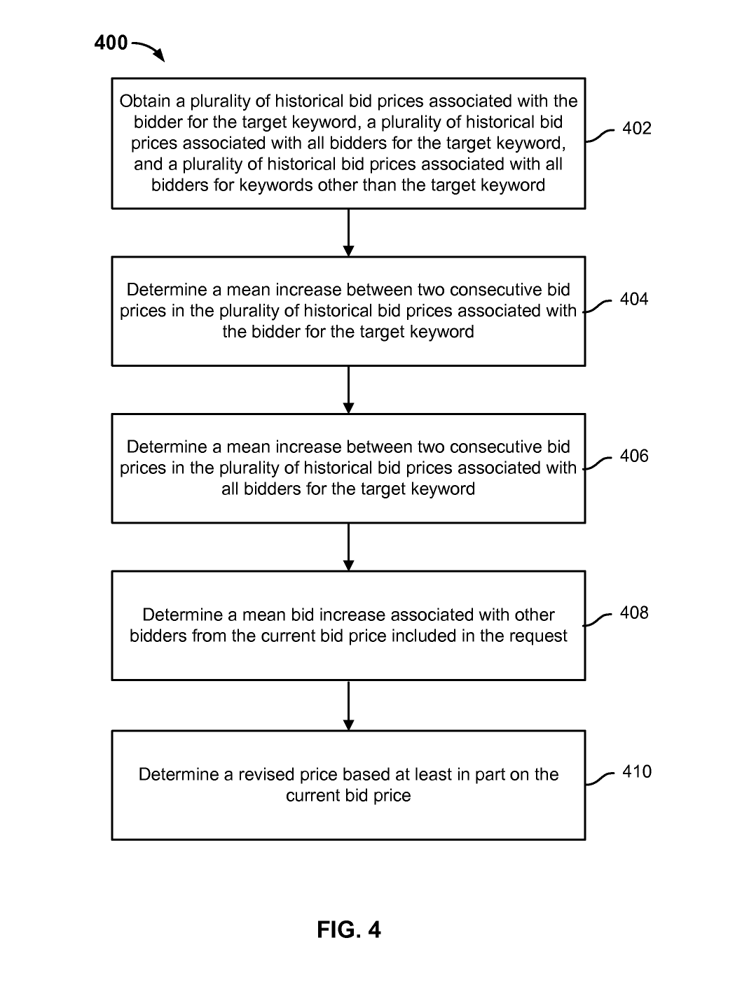

FIG. 4 is an example of a process of determining an estimated bid price in the event that the bidder has previously bid on a target keyword. In some embodiments, process 400 is used to implement 208 of process 200.

In process 400, the estimated bid price is determined for a target keyword included in a request submitted by a particular bidder. In some embodiments, the request includes a current bid price, Ps, for the target keyword.

At 402, a plurality of historical bid prices associated with the bidder for the target keyword, a plurality of historical bid prices associated with all bidders for the target keyword, and a plurality of historical bid prices associated with all bidders for keywords other than the target keyword are obtained. In some embodiments, each of the bid prices associated with any bidder for the target keyword or any other keyword is determined from the historical data included in the request and/or stored historical bidding data associated with the bidder. In some embodiments, each of the plurality of historical bid prices is associated with a time at which the bid price was made or a sequence number so that the bid price can be distinguished from a bid price that was made before or after it.

At 404, a mean increase between two consecutive bid prices in the plurality of historical bid prices associated with the bidder for the target keyword is determined. In some embodiments, each subsequent bid that the bidder makes for the target keyword is equal or greater than the bid price of the previous bid (e.g., based on the assumption that a bidder desires to increase the chances of winning advertisement spots more each subsequent time that the bidder bids on the same target keyword). In some embodiments, each subsequent bid that the bidder makes for the target keyword is less than the bid price of the previous bid so that each “increase” between two consecutive bids may also include the case where a subsequent bid price is lower than the previous bid price. Ultimately, whether the later in time of two consecutive bids is greater than, equal, or less than the previous bid, the calculation of “mean increase” as used herein remains the same. So, two bids that are consecutive in time can be compared to determine an increase from the previous bid to the next bid. Thus, each increase between every two consecutive bid prices associated with the bidder for the target keyword is determined and the mean increase is determined (i.e., the mean increase is the sum of all determined increases divided by the total number of increases). For example, the mean increase can be represented by F1 for bid prices associated with the bidder for the target keyword.

At 406, a mean increase between two consecutive bid prices in the plurality of historical bid prices associated with all bidders for the target keyword is determined. The mean increase F2 for bid prices associated with all bidders for the target keyword can be determined, in some embodiments, in a manner similar to the above described manner for determining F1 for bid prices associated with the bidder for the target keyword.

At 408, a mean bid increase associated with other bidders from the current bid price included in the request is determined. In some embodiments, the historical bidding data is searched to determine bidding data associated with other bidders to determine data that includes a first bid price that is the same current bid price that is included in the request and subsequent bid price that is higher. Then, the mean increase F3 for the increase between the determined first and subsequent bid prices is determined.

At 410, a revised price is determined based at least in part on the current bid price.

In some embodiments, the revised price Pr is determined to be the estimated bid price.

In some embodiments, the revised price Pr is determined as follows.

$$\begin{matrix}Pr = Ps + Δ P \\ = Ps + W 1 \times F 1 + W 2 \times F 2 + W 3 \times F 3\end{matrix} \qquad ( 2 )$$

Where Ps is the current bid price of the bidder for the target keyword that is included in the request, Pr is the revised price, ΔP is the price adjustment, F1 is the mean increase between two consecutive bid prices in the plurality of historical bid prices associated with the bidder for the target keyword, F2 is the mean increase between two consecutive bid prices in the plurality of historical bid prices associated with all bidders for the target keyword, F3 is the mean increase between two consecutive bid prices in the plurality of historical bid prices associated with all bidders for all keywords, and W1, W2 and W3 are set revision weightings (e.g., set by the system administrator). The values of W1, W2 and W3 can be determined based on the importance/significance associated with each of mean increases F1, F2 and F3.

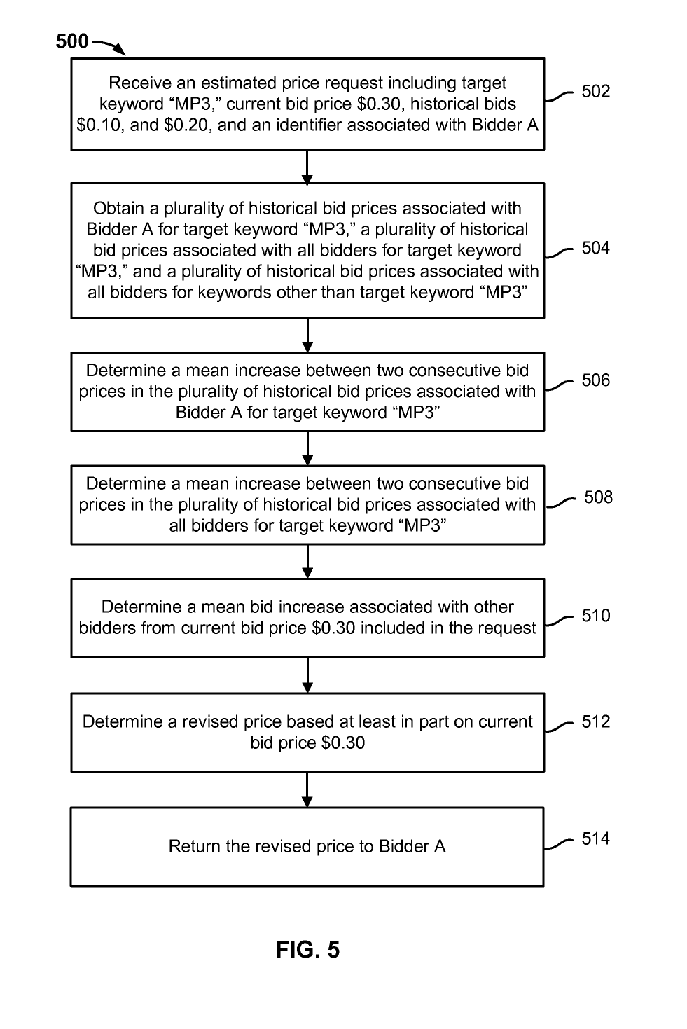

FIG. 5 is a flow diagram showing an example of a process for returning an estimated bid price. In some embodiments, process 500 is an example of using process 200. In some embodiments, process 500 is implemented at system 100.

In process 500, Bidder A has submitted a request that includes a target keyword of “MP3,” a current bid Ps by Bidder A of $0.30, and two historical bids by Bidder A for “MP3” of $0.10 and $0.20.

At 502, an estimated price request including target keyword “MP3,” current price $0.30, historical bids $0.10 and $0.20, and an identifier associated with Bidder A is received.

For example, Bidder A can send the request through a client device. In this example, as indicated by the presence of the bidder's historical bids for target keyword “MP3,” it is determined that Bidder A has previously bid on target keyword “MP3” before.

As such, the estimated bid price is determined for Bidder A based at least in part on Bidder A's historical bids for target keyword “MP3” and on the current bid price Ps of $0.30 by using a process such as 400.

At 504, a plurality of historical bid prices associated with Bidder A for target keyword “MP3,” a plurality of historical bid prices associated with all bidders for target keyword “MP3,” and a plurality of historical bid prices associated with all bidders for keywords other than target keyword “MP3” are obtained. In some embodiments, the historical data can be obtained from storage at the client and/or server systems.

At 506, a mean increase between two consecutive bid prices in the plurality of historical bid prices associated with Bidder A for target keyword “MP3” is determined. In the example, this mean increase is represented by F1.

In this example, Bidder A's historical bidding data indicates that the series of Bidder A's historical bids for target keyword “MP3” are $0.10, $0.20, $0.30.

Thus, mean increase F1 can be determined using the technique described with 404 of process 400 as: [(0.2-0.1)+(0.3-0.2)]/2=0.1.

At 508, a mean increase between two consecutive bid prices in the plurality of historical bid prices associated with all bidders for target keyword “MP3” is determined. In the example, this mean increase is represented by F2.

In this example, the historical bidding data associated with bidders other than Bidder A indicates that the series of historical bids for target keyword “MP3” are: $0.10, $0.20, $0.30, $0.50, $0.70.

Thus, mean increase F2 can be determined using the technique described with 406 of process 400 as: [(0.2-0.1)+(0.3-0.2)+(0.5-0.3)+(0.7-0.5)]/4=0.15.

At 510, a mean bid increase associated with other bidders from current bid price $0.30 included in the request is determined. In the example, this mean increase is represented by F3.

In this example, the historical bidding data associated with three other bidders (Bidder B, Bidder C, and Bidder D) indicates that each of the three bidders had once bid at the current bid price included in the request of $0.30 and then increased their bid prices at a subsequent bidding event. In the example, the bids at the current bid price and the subsequent bids could be for the target keyword or another keyword. The relevant historical bidding data of Bidder B, Bidder C, and Bidder D are as follows:

Bidder B: 0.3, 0.5;

Bidder C: 0.3, 0.7;

Bidder D: 0.3, 0.8.

Thus, mean increase F3 can be determined using the technique described with 408 of process 400 as: [(0.5-0.3)+(0.7-0.3)+(0.8-0.3)]/3=0.37.

At 512, a revised price is determined. In the example, the revised price is represented by Pr.

In this example, W1=0.1, W2=0.5, and W3=0.4 and so the revised price is determined as follows:

$$\begin{matrix}Pr = Ps + Δ P \\ = Ps + W 1 \times F 1 + W 2 \times F 2 + W 3 \times F 3 \\ = 0.3 + 0.1 \times 0.1 + 0.5 \times 0.15 + 0.4 \times 0.37 \\ = 0.3 + 0.233 = 0.533\end{matrix}$$

At 514, the revised price is returned to Bidder A.

The Pr ($0.533) is determined to be the estimated bid price to be returned to Bidder A. In some embodiments, the website or search engine that determined the estimated bid price uses the bid price as the one that it recommends to the requesting bidder.

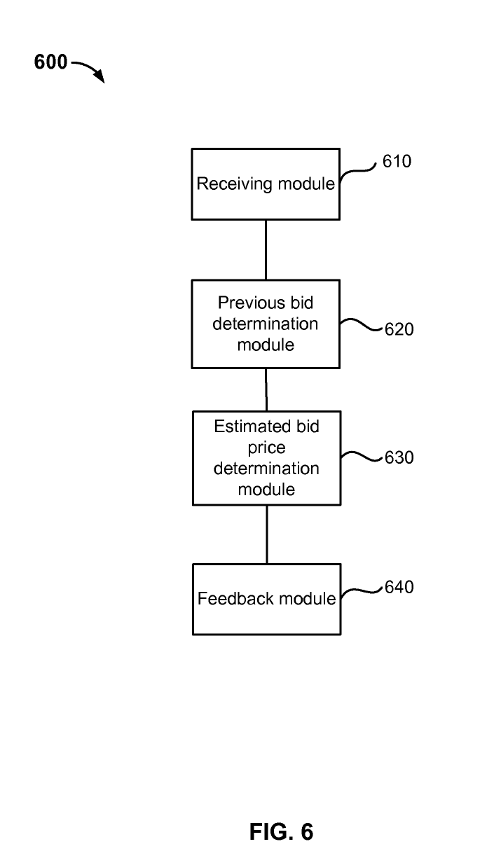

FIG. 6 is a diagram showing an embodiment of a system for providing estimates of bid prices of target keywords.

The modules and submodules can be implemented as software components executing on one or more processors, as hardware such as programmable logic devices and/or Application Specific Integrated Circuits designed to perform certain functions, or a combination thereof. In some embodiments, the modules and submodules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules and submodules may be implemented on a single device or distributed across multiple devices.

Receiving module 610 is configured to receive price requests for target keywords sent by bidders through a client system.

Previous bid determination module 620 is configured to judge whether the bidder associated with a request has previously engaged in bidding for the target keyword included in the request.

If the determination result of the previous bid determination module 620 for a request is negative (i.e., it is determined that the bidder has not previously bid on the target keyword), then estimated bid price determination module 630 is configured to determine the basic price for the target keyword. In some embodiments, an example of determining the basic price, which is to be used as the estimated bid price, is process 300. Otherwise, if the determination result of the previous bid determination module 620 for a request is positive (i.e., it is determined that the bidder has previously bid on the target keyword), then estimated bid price determination module 630 is configured to revise the current bid price included in the request based on the historical bidding data. In some embodiments, an example of determining a revised price, which is to be used as the estimated bid price, is process 400.

Feedback module 640 is configured to return a price for the target keyword to the client, based on the estimated bid price determined by estimated bid price determination module 630.

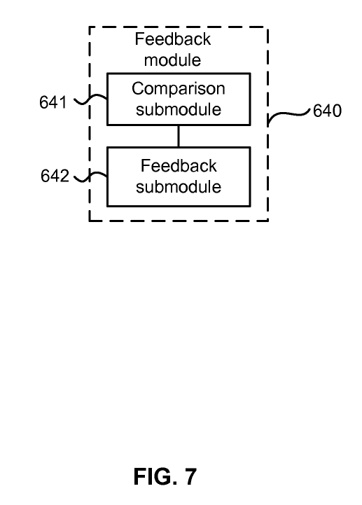

FIG. 7 is an example of a feedback module. In some embodiments, feedback module 640 of system 600 is implemented with the example of FIG. 7. In the example, the feedback module includes comparison submodule 641 and feedback submodule 642.

Comparison submodule 641 is configured to compare the estimated bid prices determined by estimated bid price determination module 630 against the upper price limit for the target keyword for the bidder associated with the request.

Feedback submodule 642 is configured to return the estimated bid price to the client if the estimated bid price is greater than the upper price limit, but if the estimated bid price is equal or greater than the upper price limit, then feedback submodule 642 returns the value of the upper price limit to the client.

In some embodiments, feedback module 640 includes:

An upper limit determination module that is configured to obtain the mean and standard deviation of the bidder's purchase prices for the target keyword, for example, using a technique similar to the one described for process 200.

As can be seen through the description of the implementation means above, technical personnel in this field can clearly understand that the present disclosure can be realized with the aid of software plus the necessary common hardware platform. Based on such an understanding, the technical proposal of the present disclosure, whether intrinsically or with respect to portions that contribute to the existing technology, is realizable in the form of software products; said computer software products can be stored on storage media, such as ROM/RAM, diskettes, and compact discs, and include a certain number of commands used to cause a set of computing equipment (which could be a personal computer, server, or network equipment) to execute the means or certain portions of the means described in the embodiments of the present disclosure.

Each of the embodiments contained in the present disclosure is described in a progressive manner, and the descriptions thereof may be mutually referenced for portions of each embodiment that are identical or similar; the explanation of each embodiment focuses on areas of difference from the other embodiments. Particularly in regard to the system embodiment, because it is fundamentally similar to the method embodiment, the description is relatively simple; portions of the explanation of the method embodiment can be referred to for the relevant aspects. The system embodiment described above is only schematic; elements therein described as separate parts may or may not be physically separate, and parts shown as elements may or may not be physical elements, i.e., they may be located in one place, or they may be distributed onto multiple network elements. A portion or all of the modules herein may be chosen based on actual requirements to achieve the objectives of the present disclosure. Ordinary technical personnel in this field will be able to understand and implement it without expending creative labor.

The present disclosure can be used in many general purpose or specialized computer system environments or configurations. For example: personal computers, servers, handheld devices or portable equipment, tablet type equipment, multiprocessor systems, microprocessor-based systems, set-top boxes, programmable consumer electronic equipment, networked PCs, minicomputers, mainframe computers, distributed computing environments that include any of the systems or equipment above, and so forth.

The present disclosure can be described in the general context of computer executable commands executed by a computer, such as a program module. Generally, program modules include routines, programs, objects, components, data structures, etc. to execute specific tasks or achieve specific abstract data types. The present disclosure can also be carried out in distributed computing environments; in such distributed computing environments, tasks are executed by remote processing equipment connected via communication networks. In distributed computing environments, program modules can be located on storage media at local or remote computers that include storage equipment.

The description above is only a specific means of implementing the present disclosure; it should be pointed out that ordinary technical personnel in this field of technology, on the premise of non-departure from the principles of the present disclosure, can also produce a number of improvements and embellishments, and that such improvements and embellishments should also be regarded as within the scope of protection of the present disclosure.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of providing bid price estimates, including:
receiving a request to estimate a bid price associated with a target keyword for a bidder;
determining whether the bidder has previously bid on the target keyword;
in the event that the bidder has not previously bid on the target keyword, determining an estimated bid price based at least in part on a plurality of historical bid prices associated with the bidder corresponding to keywords other than the target keyword and a plurality of historical bid prices associated with other bidders corresponding to the target keyword; and
in the event that the bidder has previously bid on the target keyword, determining the estimated bid price based at least on revising a current bid price associated with the request; and
returning the estimated bid price associated with the target keyword.

2. The method of claim 1, wherein the request includes one or more of the following: an identifier associated with the bidder, the current bid price for the target keyword, and the target keyword.

3. The method of claim 1, wherein in the event that the bidder has not previously bid on the target keyword:
determining the bidder's median purchase price corresponding to keywords other than the target keyword and a number of other keywords that have been purchased by the bidder;
determining the median purchase price associated with other bidders corresponding to the target keyword and a number of other bidders who have purchased the target keyword; and
comparing the determined number of keywords purchased by the bidder and the number of other bidders who have purchased the target keyword to a threshold value to select a basic price.

4. The method of claim 3, wherein the basic price is determined as the estimated bid price.

5. The method of claim 3, wherein the basic price is selected to be one of the bidder's median purchase prices corresponding to keywords other than the target keyword or the median purchase price associated with other bidders corresponding to the target keyword.

6. The method of claim 1,wherein in the event that the bidder has previously bid on the target keyword:
obtaining a plurality of historical bid prices associated with the bidder for the target keyword, a plurality of historical bid prices associated with all bidders for the target keyword, and a plurality of historical bid prices associated with all bidders for keywords other than the target keyword;
determining a mean increase between two consecutive bid prices in the plurality of historical bid prices associated with the bidder for the target keyword;
determining a mean increase between two consecutive bid prices in the plurality of historical bid prices associated with all bidders for the target keyword;
determining a mean bid increase associated with other bidders from the current bid price included in the request; and
determining a revised price based at least in part on the current bid price.

7. The method of claim 6, wherein the revised price is determined as the estimated bid price.

8. The method of claim 1, wherein the bid price is associated with online advertising at a website or search engine.

9. A computer program product for providing bid price estimates, the computer program product being embodied in a non-transitory computer readable storage medium and comprising computer instructions for:
receiving a request to estimate a bid price associated with a target keyword for a bidder;
determining whether the bidder has previously bid on the target keyword;
in the event that the bidder has not previously bid on the target keyword, determining an estimated bid price based at least in part on a plurality of historical bid prices associated with the bidder corresponding to keywords other than the target keyword and a plurality of historical bid prices associated with other bidders corresponding to the target keyword; and
in the event that the bidder has previously bid on the target keyword, determining the estimated bid price based at least on revising a current bid price associated with the request; and
returning the estimated bid price associated with the target keyword.

10. A system of providing bid price estimates, including:
a processor configured to:
receive a request to estimate a bid price associated with a target keyword for a bidder;
determine whether the bidder has previously bid on the target keyword;
in the event that the bidder has not previously bid on the target keyword, determine an estimated bid price based at least in part on a plurality of historical bid prices associated with the bidder corresponding to keywords other than the target keyword and a plurality of historical bid prices associated with other bidders corresponding to the target keyword; and
in the event that the bidder has previously bid on the target keyword, determine the estimated bid price based at least on revising a current bid price associated with the request; and
return the estimated bid price associated with the target keyword; and
a memory coupled to the processor and configured to provide the processor with instructions.

11. The system of claim 10, wherein the request includes one or more of the following: an identifier associated with the bidder, the current bid price for the target keyword, and the target keyword.

12. The system of claim 10, wherein in the event that the bidder has not previously bid on the target keyword the processor is configured to:
determine the bidder's median purchase price corresponding to keywords other than the target keyword and a number of other keywords that have been purchased by the bidder;
determine the median purchase price associated with other bidders corresponding to the target keyword and a number of other bidders who have purchased the target keyword; and
compare the determined number of keywords purchased by the bidder and the number of other bidders who have purchased the target keyword to a threshold value to select a basic price.

13. The system of claim 12, wherein the basic price is determined as the estimated bid price.

14. The system of claim 12, wherein the basic price is selected to be one of the bidder's median purchase prices corresponding to keywords other than the target keyword or the median purchase price associated with other bidders corresponding to the target keyword.

15. The system of claim 10, wherein in the event that the bidder has previously bid on the target keyword the processor is configured to:
obtain a plurality of historical bid prices associated with the bidder for the target keyword, a plurality of historical bid prices associated with all bidders for the target keyword, and a plurality of historical bid prices associated with all bidders for keywords other than the target keyword;
determine a mean increase between two consecutive bid prices in the plurality of historical bid prices associated with the bidder for the target keyword;
determine a mean increase between two consecutive bid prices in the plurality of historical bid prices associated with all bidders for the target keyword;
determine a mean bid increase associated with other bidders from the current bid price included in the request; and
determine a revised price based at least in part on the current bid price.

16. The system of claim 15, wherein the revised price is determined as the estimated bid price.

17. The system of claim 10, wherein the bid price is associated with online advertising at a website or search engine.
